(19) United States
(12) Patent Application Publication
(10) Pub. No.: US 2023/0372910 A1
(43) Pub. Date: Nov. 23, 2023

(54) FENTON-LIKE CATALYST MATERIAL WITH ELECTRON-POOR Cu CENTER, AND PREPARATION METHOD AND USE THEREOF

(71) Applicants: NANJING UNIVERSITY, Nanjing (CN); NANJING UNIVERSITY & YANCHENG ACADEMY OF ENVIRONMENTAL PROTECTION TECHNOLOGY AND ENGINEERING, Yancheng (CN); NANHUAN YANCHENG ENVIRONMENTAL PROTECTION TECHNOLOGY CO., LTD.

(72) Inventors: Jinnan WANG, Nanjing (CN); Zhiqun XIE, Nanjing (CN); Lifang CHEN, Nanjing (CN); Jiali ZHOU, Nanjing (CN); Zhiping LYU, Nanjing (CN); Aimin LI, Nanjing (CN)

(73) Assignees: NANJING UNIVERSITY, Nanjing (CN); NANJING UNIVERSITY & YANCHENG ACADEMY OF ENVIRONMENTAL PROTECTION TECHNOLOGY AND ENGINEERING, Yancheng (CN); NANHUAN YANCHENG ENVIRONMENTAL PROTECTION TECHNOLOGY CO., LTD., Yancheng (CN)

(21) Appl. No.: 18/028,229

(22) PCT Filed: Aug. 24, 2021
(86) PCT No.: PCT/CN2021/114262

§ 371 Date: Mar. 24, 2023

(30) Foreign Application Priority Data
Sep. 24, 2020 (CN) 202011028627.X

(51) Int. Cl. B01J 23/843; B01J 37/03; B01J 6/00; B01J 37/08; B01J 21/04; C02F 1/72

(52) U.S. Cl. CPC B01J 23/8437; B01J 37/031; B01J 6/001; B01J 37/08; B01J 21/04; C02F 1/722; C02F 2101/38

(57) ABSTRACT

A Fenton-like catalyst material with an electron-poor Cu center and a preparation method and use thereof are provided. The preparation method includes: step 1: dissolving bismuth nitrate pentahydrate in a nitric acid solution and diluting a resulting solution with deionized water to obtain a solution A; step 2: adding citric acid to the solution A and adjusting a pH of a resulting solution with ammonia water to obtain a solution B; step 3: dissolving aluminium isopropoxide (AIP), copper chloride dihydrate, and glucose in the solution B to obtain a suspension C; step 4: stirring the suspension C at a high temperature to allow evaporation until a solid D is completely precipitated; and step 5: subjecting the solid D to calcination in a muffle furnace to obtain the Fenton-like catalyst material. Under neutral conditions, the catalyst material exhibits a prominent removal effect for various toxic organic pollutants, especially for phenolic pollutants.

### CROSS REFERENCE TO THE RELATED APPLICATIONS

This application is the national phase entry of International Application No. PCT/CN2021/114262, filed on Aug. 24, 2021, which is based upon and claims priority to Chinese Patent Application No. 202011028627.X, filed on Sep. 24, 2020, the entire contents of which are incorporated herein by reference.

### TECHNICAL FIELD

The present disclosure belongs to the field of materials and the present disclosure relates to a Fenton-like catalyst material, and in particular, to a Fenton-like catalyst material with an electron-poor Cu center, and a preparation method and use thereof.

### BACKGROUND

Traditional Fenton oxidation includes a homogeneous Fenton reaction and a heterogeneous Fenton reaction. The homogeneous Fenton reaction refers to a process in which a hydroxyl radical (HO·) with super high oxidation capacity is produced through a reaction of Fe²⁺ with H₂O₂ to degrade the pollutant in water. However, the traditional Fenton technique has many shortcomings, such as severe acidic conditions (pH<3), generation of iron sludge during the reaction, and extremely-low utilization of oxidants, which greatly limit the application of the traditional Fenton technique in actual wastewater treatment. As a result, heterogeneous Fenton catalysis has attracted widespread attention. In the research on heterogeneous Fenton catalysis, a dual-reaction center mechanism has aroused great interest among researchers due to its unique advantages such as high oxidant utilization and excellent catalytic stability. However, the traditional Fenton-like catalyst with an electron-rich Cu center still has many shortcomings, such as low mineralization of phenolic pollutants and poor degradation of large-molecular-weight organic pollutants, which hinders the development of the traditional Fenton-like catalyst. The existing patents involved are as follows:

The patent with application No. 20110856060.7 discloses an electro-Fenton water treatment method based on an iron-containing clay mineral-supported palladium catalyst, where palladium is supported on an iron-containing clay mineral through a reduction reaction to obtain a palladium-iron integrated catalyst, and then the palladium-iron integrated catalyst is added to an electro-Fenton water treatment device for catalysis to produce hydroxyl radicals to degrade organic pollutants in water. Experimental results have shown that the catalyst can remove 92% of 0.5 mmol/L sodium benzoate within 60 minutes, but the device requires a stable direct-current (DC) power supply, resulting in high electric energy consumption. In addition, the use of the precious metal leads to an extremely high preparation cost of the catalyst and the traditional Fenton-like electron transfer mechanism will inevitably cause a heavy loss of the precious metal. These defects heavily limit the application of the catalyst in actual wastewater treatment.

The patent with application No. 201611147885.3 discloses a preparation method of a mesoporous silicon-supported iron-copper bimetal heterogeneous Fenton catalyst material. The mesoporous silicon-supported iron-copper composite metal oxide catalyst material prepared by the preparation method has the characteristics of wide pore size distribution, large specific surface area (SSA), and relatively uniform metal distribution. However, in a process of degrading dye wastewater, the oxidant and the catalyst need to be added in large quantities. In this experiment, H₂O₂ of 0.15 M and the catalysts of 2 g/L are added to dye wastewater to be degraded, and only 62.3% degradation can be achieved after 300 minutes. This catalytic efficiency leads to a large consumption of the oxidants, resulting in a high treatment cost. In addition, the treatment effect is not significant.

The patent with application No. 201510939912. X discloses a preparation method of an iron-copper-aluminium oxide composite catalyst, where a mesoporous material is modified to obtain a prominent nanolayer, and then a bimetallic component is supported on the nanolayer to obtain a nanolayer with the active component highly dispersed. However, the entire Fenton reaction process takes a long time to effectively remove the pollutant and the entire reaction still follows the mechanism of the classical Fenton reaction. Moreover, this catalyst still relies on a redox reaction based on the single metal site to achieve the activation of hydrogen peroxide and the utilization of hydrogen peroxide in the system is still very low.

The patent with application No. CN201811311154.7 discloses a preparation method for a Fenton-like catalyst material with a dual-reaction center. The catalyst material has a complete bulbous mesoporous structure and a large SSA and can expose many catalytic active sites. Such that H₂O₂ can undergo a reduction reaction at the electron-rich center as much as possible to produce hydroxyl radicals. The new catalyst material exhibits a long-lasting removal effect for various toxic organic pollutants under neutral conditions and can achieve the highly-selective conversion of H₂O₂. However, the catalyst material has very low mineralization when used in the catalytic degradation of a phenolic compound and exhibits a poor catalytic effect when used in the degradation of a macromolecular substance such as a dye.

The traditional Fenton-like catalysts with an electron-rich Cu center still have defects such as low mineralization for phenolic pollutants and poor catalytic effect for macromolecular pollutants. Recent studies have shown that a σ-Cu-ligand action is formed between phenolic hydroxyl and surface copper. Cu (II) in the σ-Cu (II) complex could be reduced to Cu (I) by oxidization of the HO-adduct radicals to hydroxylation products. Such reaction not only prevented Cu (II) from oxidizing H₂O₂ to HO₂·/O₂·⁻, but also promotes the redox cycle of Cu (II)/Cu (I) (2). Therefore, the σ-Cu-ligand action plays an important role in the selective degradation of a phenolic compound and the efficient utilization of H₂O₂. However, to achieve a synergistic effect between the dual-reaction center and the σ-Cu-ligand, there are several technical problems to be solved: (1) The construction of the traditional Fenton-like catalyst with an electron-rich Cu center will hinder an action of a phenolic compound with surface Cu, which limits the σ-Cu-ligand action. (2) the dual-reaction center can be induced only if the polarization difference is strong enough, and thus the appropriate metal or metal oxide needs to be supported or doped. (3) The lattice doping of Cu in a catalyst plays an important role in the establishment of a dual-reaction center, and thus how to improve the lattice doping of Cu is a challenge.

### SUMMARY

The present disclosure provides a Fenton-like catalyst material with an electron-poor Cu center, a preparation method, and use thereof, such as to overcome the shortcomings of the prior art.

To achieve the above objective, the present disclosure provides a preparation method for a Fenton-like catalyst material with an electron-poor Cu center, including the following steps:
Step 1: dissolving bismuth nitrate pentahydrate in a nitric acid solution, and diluting a resulting solution with deionized water to obtain a solution A;
Step 2: adding citric acid to solution A, and adjusting the pH of the resulting solution with ammonia water to obtain a solution B;
Step 3: dissolving aluminium isopropoxide (AIP), copper chloride dihydrate, and glucose in solution B to obtain a suspension C;
Step 4: stirring the suspension C at a high temperature to allow evaporation until a solid D is completely precipitated; and
Step 5: subjecting the solid D to calcination in a muffle furnace to obtain the Fenton-like catalyst material.

Further, for the preparation method of a Fenton-like catalyst material with an electron-poor Cu center provided by the present disclosure, in step 1, the nitric acid solution has a concentration of 1 mol/L to 2 mol/L and a ratio of the bismuth nitrate pentahydrate to the nitric acid solution is (0.32-3.28) g:5 mL.

Further, for the preparation method of a Fenton-like catalyst material with an electron-poor Cu center provided by the present disclosure, a ratio of the citric acid to the bismuth nitrate pentahydrate is (0.3-0.9) g:(0.32-3.28) g.

Further, for the preparation method of a Fenton-like catalyst material with an electron-poor Cu center provided by the present disclosure, in step 2, the pH of the solution is adjusted with the ammonia water to 5 to 9.

Further, for the preparation method of a Fenton-like catalyst material with an electron-poor Cu center provided by the present disclosure, in step 3, the AIP, the copper chloride dihydrate, and the glucose are added in a ratio of (6.0-9.0) g:(0.1-0.8) g:(4.0-8.0) g.

Further, for the preparation method of a Fenton-like catalyst material with an electron-poor Cu center provided by the present disclosure, in step 4, the suspension C is stirred at a high temperature of 100° C. and a rotational speed of 100 r/min to 200 r/min.

Further, for the preparation method of a Fenton-like catalyst material with an electron-poor Cu center provided by the present disclosure, in step 5, the calcination in the muffle furnace is conducted at 400° C. to 600° C. for 3 h to 7 h with a heating rate of 5° C./min to 10° C./min.

A Fenton-like catalyst material with an electron-poor Cu center prepared by the preparation method is also within the protection scope of the present disclosure and presents a fluffy cotton-like porous morphology as a whole. According to nitrogen adsorption and desorption isotherm and a pore size distribution curve, it can be known that the synthesized Fenton-like catalyst mainly has a mesoporous structure and a pore size distribution of about 7.1 nm. The catalyst material has a structural formula of (Bi, Cu)Al₂O₃, where a mass fraction of Cu is 3.0% to 9.0% and a mass fraction of Bi₁₂O₁₅Cl₆ is 5.4% to 50.4%. Due to the formation of an electron-poor Cu center, the catalyst material can achieve a synergistic effect between the dual-reaction center and the σ-Cu-ligand when used in the catalytic degradation of a phenolic pollutant.

The present disclosure also provides a use of the Fenton-like catalyst material with an electron-poor Cu center, where the Fenton-like catalyst material is used in combination with H₂O₂ in water to degrade the organic pollutant.

Further, for the use of the Fenton-like catalyst material with an electron-poor Cu center provided by the present disclosure, the organic pollutant is any one selected from the group consisting of rhodamine B, bisphenol A (BPA), and dichlorophenol (DCP).

The present disclosure discloses a Fenton-like catalyst material with an electron-poor Cu center and a preparation method thereof. In the preparation method, based on the doping of two catalysts γ-Cu—Al₂O₃ and Bi₁₂O₁₅Cl₆, γ-Cu—Al₂O₃— is synthesized in one step through a modified evaporation-induced self-assembly reaction and Bi₁₂O₁₅Cl₆ is supported; and Bi with stronger electronegativity is used to induce an electron-poor Cu center in the catalyst. Unlike the traditional catalyst with an electron-rich copper center, the electron-poor copper center is conducive to the formation of σ-Cu-ligand with a phenolic compound. H₂O₂ could directly oxidize σ-Cu-ligand to HO-adduct radicals with the generation of ·OH. Meanwhile, Cu(II) in the σ-Cu(II) complexes could be reduced to Cu(I) by oxidization of the HO-adduct radicals. It should be noted that although the σ-Cu-ligand effect is gradually weakened over time due to the decrease of the phenolic compound, the dual-reaction center plays a dominant role in the catalytic reaction. The degradation-simulated BPA and DCP wastewater tests have shown that the new (Bi, Cu)Al₂O₃ has extremely high Fenton catalytic efficiency and stability.

The present disclosure has the following beneficial effects:
1. The prepared Fenton-like catalyst material has a fluffy porous structure and a large SSA and can expose abundant effective active sites.
2. The prepared catalyst material can exhibit excellent catalytic activity and stability for organic pollutants such as BPA, rhodamine B, and DCP under neutral conditions.
3. The formation of the electron-poor Cu center makes the catalyst easy to form a σ-Cu-ligand with a phenolic compound, which greatly improves the degradation rate for the phenolic compound. In addition, a synergistic effect between the σ-Cu-ligand and the dual-reaction center greatly improves the mineralization of the system for a phenolic pollutant.
4. The establishment of the dual-reaction center also enables the catalyst to effectively utilize the oxidants in a system, and thus the utilization of hydrogen peroxide in the system is very high.

### BRIEF DESCRIPTION OF THE DRAWINGS

FIG. 1 is a scanning electron microscopy (SEM) image of (Bi,Cu)Al₂O₃;

FIGS. 2A-2B are energy-dispersive X-ray spectroscopy (EDS) spectra illustrating the distribution of elements in (Bi,Cu)Al₂O₃;

FIGS. 3A-3B show transmission electron microscopy (TEM) images of (Bi,Cu)Al₂O₃;

FIGS. 4A-4B show the N₂ adsorption and desorption isotherm and a pore size distribution curve of (Bi,Cu)Al₂O₃.

FIG. 5 shows an X-ray diffraction (XRD) pattern of (Bi,Cu)Al₂O₃;

FIGS. 6A-6C show X-ray photoelectron spectroscopy (XPS) spectra of Bi 4f, Cu 2p, and Al 2p orbits of (Bi,Cu)Al₂O₃;

FIG. 7 shows an electron-spin resonance (ESR) spectrum of Cu in (Bi,Cu)Al₂O₃;

FIG. 8 shows infrared (IR) spectra of (Bi,Cu)Al₂O₃ in the degradation of BPA at various stages;

FIG. 9A shows electron paramagnetic resonance (EPR) signals of HO₂·/O₂·— in a 5,5-dimethyl-1-pyrroline-N-oxide (DMPO) capture suspension and FIG. 9B shows EPR signals of ·OH in a DMPO capture suspension;

FIG. 10 shows the degradation effects of (Bi,Cu)Al₂O₃ samples with different Bi₁₂O₁₅Cl₆ contents for BPA with an initial concentration of 20 ppm;

FIG. 11 shows the degradation effects of (Bi,Cu)Al₂O₃ samples with different H₂O₂ contents for BPA;

FIGS. 12A-12B show in situ Raman spectra of (Bi,Cu)Al₂O₃ under different organic systems; and

FIG. 13 shows a mechanism of interaction between (Bi,Cu)Al₂O₃ and a hydrogen peroxide aqueous solution.

### DETAILED DESCRIPTION OF THE EMBODIMENTS

The present disclosure will be further described below in conjunction with specific examples.

### Example 1

In this example, a preparation method of a Fenton-like catalyst material with an electron-poor Cu center was provided, including the following steps:
Step 1: 0.32 g of bismuth nitrate pentahydrate was dissolved in 5 mL of a nitric acid solution (2 M), and a resulting solution was diluted with deionized water to 100 mL to obtain a solution A;
Step 2: 0.3 g of citric acid was dissolved in solution A obtained in step 1, a resulting solution was stirred at a rate of 100 r/min, and a pH was adjusted with ammonia water to 6.5 to obtain a solution B;
Step 3: 8.4 g of AIP, 0.4 g of copper chloride dihydrate, and 7.2 g of glucose were added to the solution B obtained in step 2, and a resulting mixture was stirred at a rate of 100 r/min for 12 h to obtain a solution C;
Step 4: the solution C obtained in step 3 was placed in an electrothermal furnace and then heated and stirred at 100° C. until the water was completely evaporated to obtain a solid D; and
Step 5: the solid D obtained in step (4) was placed in a corundum crucible, and then heated at a heating rate of 5° C./min to 600° C. and kept at the temperature for 6 h in a muffle furnace for calcination to obtain the Fenton-like catalyst material with an electron-poor Cu center in which a mass fraction of Bi₁₂O₁₅Cl₆ was 5.4%.

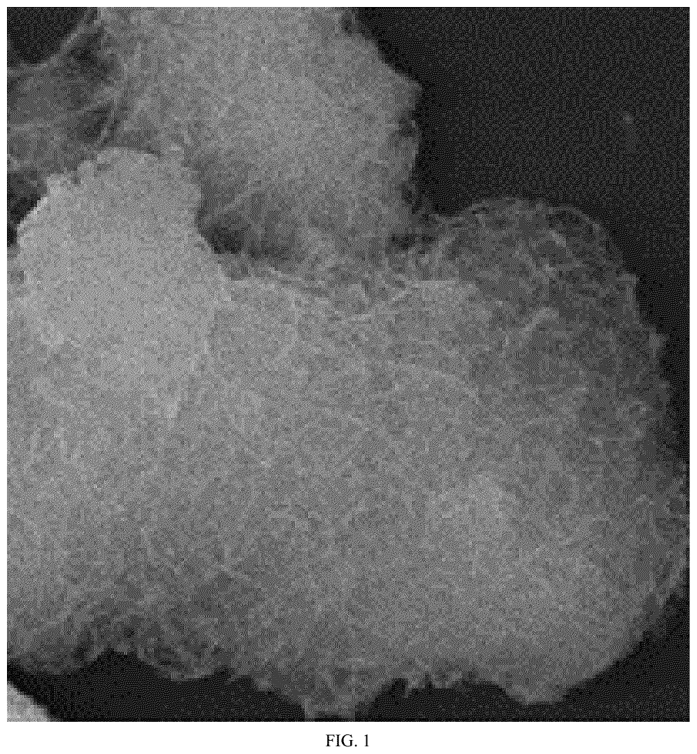

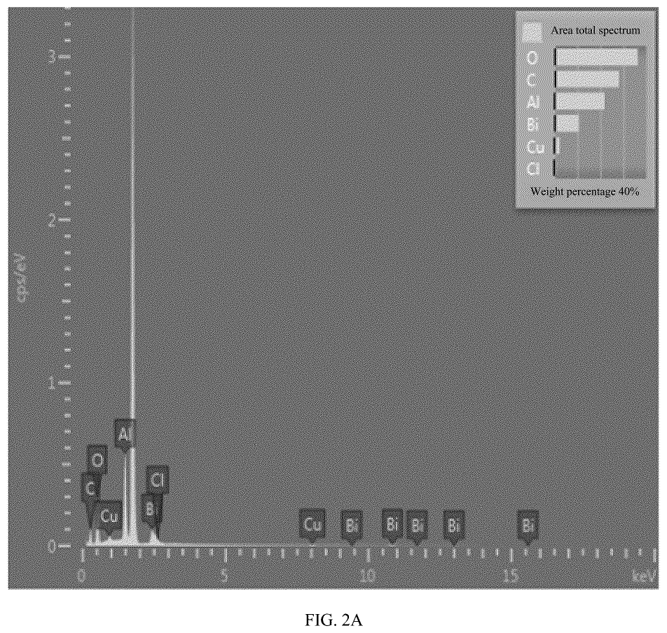

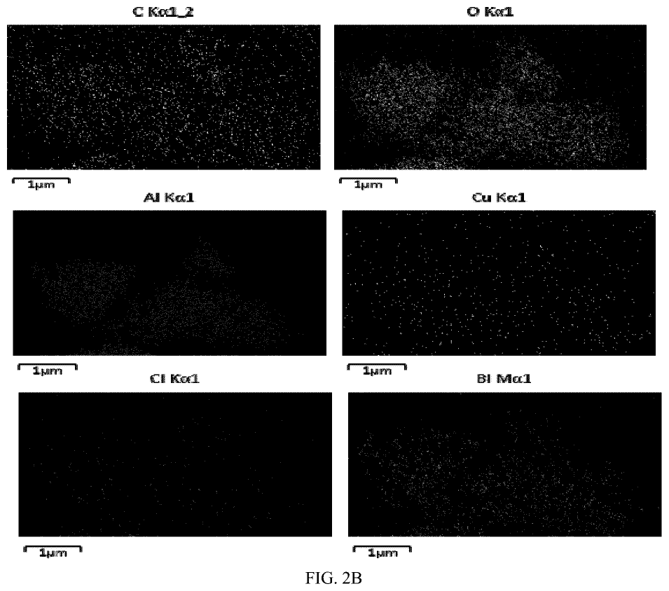

The catalyst material prepared above was characterized by SEM and EDS. It can be seen from FIG. 1 that the catalyst obtained through the improved evaporation-induced self-assembly reaction and calcination has a fluffy and porous cotton-like amorphous structure; which provides a large number of active sites for a catalytic reaction. It can be seen from FIGS. 2A-2B that Cu, C, Bi, O, Cl, and Al elements are uniformly distributed in the bulk phase, indicating that the incorporated Cu and the generated Bi₁₂O₁₅Cl₆ are well distributed in a structure of the matrix material Al₂O₃.

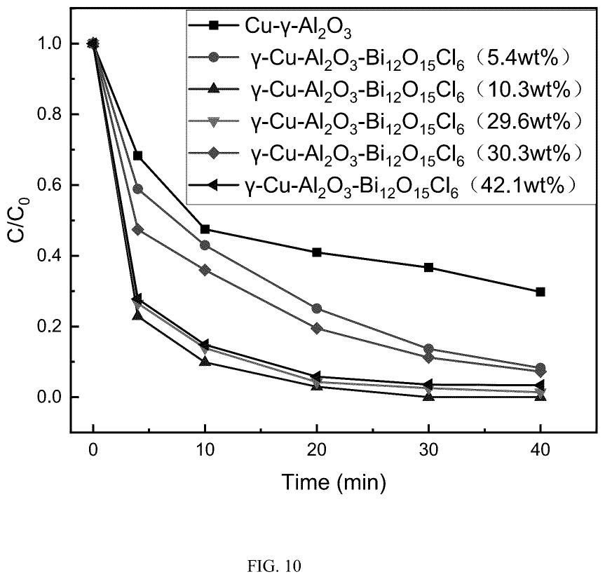

The 20 mg/L BPA solution was prepared in a 150 mL Erlenmeyer flask, 0.1 g of the catalyst material obtained in step 5 was added to the Erlenmeyer flask and a resulting mixture was stirred in a constant-temperature water bath at 35° C. for 30 minutes to achieve an adsorption equilibrium. Then 0.1 mL of a hydrogen peroxide solution with a mass fraction of 30% was added and then 1 mL of a reaction solution was collected every 5 minutes filtered through a 0.45 μm filter membrane, and subjected to high-performance liquid chromatography (HPLC) analysis to obtain BPA concentrations at different reaction time points. Test results were shown in FIG. 10.

### Example 2

In this example, a preparation method of a Fenton-like catalyst material with an electron-poor Cu center was provided, including the following steps:
Step 1: 0.64 g of bismuth nitrate pentahydrate was dissolved in 5 mL of a nitric acid solution (2 M) and a resulting solution was diluted with deionized water to 100 mL to obtain a solution A;
Step 2: 0.3 g of citric acid was dissolved in solution A obtained in step 1, a resulting solution was stirred at a rate of 100 r/min, and a pH was adjusted with ammonia water to 6.5 to obtain a solution B;
Step 3: 8.4 g of AIP, 0.4 g of copper chloride dihydrate, and 7.2 g of glucose were added to the solution B obtained in step 2 and a resulting mixture was stirred at a rate of 100 r/min for 12 h to obtain a solution C;
Step 4: the solution C obtained in step 3 was placed in an electrothermal furnace and then heated and stirred at 100° C. until the water was completely evaporated to obtain a solid D; and
Step 5: the solid D obtained in step 4 was placed in a corundum crucible and then heated at a heating rate of 5° C./min to 600° C. and kept at the temperature for 6 h in a muffle furnace for calcination to obtain the Fenton-like catalyst material with an electron-poor Cu center in which a mass fraction of Bi₁₂O₁₅Cl₆ was 10.3%.

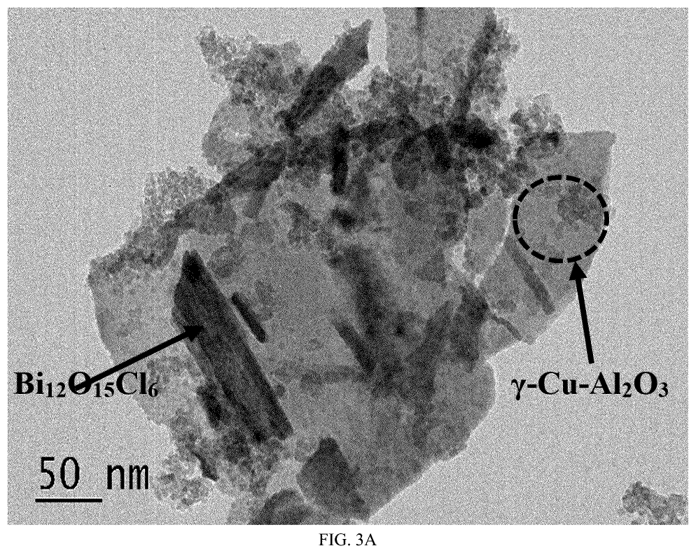

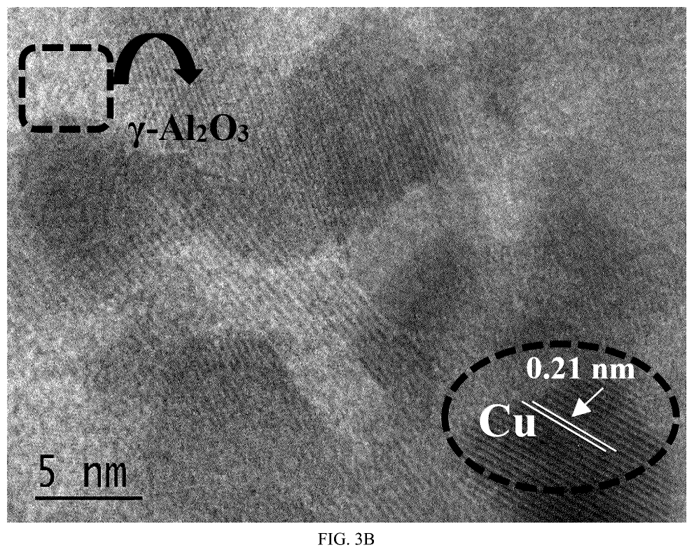

The catalyst material obtained above was characterized by TEM. It can be seen from FIGS. 3A-3B that Bi₁₂O₁₅Cl₆ nanoparticles adhere to a surface of γ-Cu—Al₂O₃ to form a heterogeneous structure. Notably, the high-resolution transmission electron microscopy (HRTEM) images clearly show that copper is completely embedded into the γ-Al₂O₃ lattice. Lattice fringes with an interplanar crystal spacing of 0.21 nm correspond to the (111) plane of Cu, and a cloud-like structure without lattice fringes is γ-Al₂O₃ of an amorphous structure.

A 20 mg/L BPA solution was prepared in a 150 mL Erlenmeyer flask, 0.1 g of the catalyst material obtained in step 5 was added to the Erlenmeyer flask, and a resulting mixture was stirred in a constant-temperature water bath at 35° C. for 30 minutes to achieve an adsorption equilibrium; and then 0.1 mL of a hydrogen peroxide solution with a mass fraction of 30% was added and then 1 mL of a reaction solution was collected every 5 minutes, filtered through a 0.45 m filter membrane, and subjected to HPLC analysis to obtain BPA concentrations at different reaction time points. Test results were shown in FIG. 10.

### Example 3

In this example, a preparation method of a Fenton-like catalyst material with an electron-poor Cu center was provided, including the following steps:
Step 1: 1.28 g of bismuth nitrate pentahydrate was dissolved in 5 mL of a nitric acid solution (2 M), and a resulting solution was diluted with deionized water to 100 mL to obtain a solution A;
Step 2: 0.3 g of citric acid was dissolved in solution A obtained in step 1, a resulting solution was stirred at a rate of 100 r/min, and a pH was adjusted with ammonia water to 6.5 to obtain a solution B;
Step 3: 8.4 g of AIP, 0.4 g of copper chloride dihydrate and 7.2 g of glucose were added to the solution B obtained in step 2. A resulting mixture was stirred at a rate of 100 r/min for 12 h to obtain a solution C;
Step 4: the solution C obtained in step 3 was placed in an electrothermal furnace and then heated and stirred at 100° C. until the water was completely evaporated to obtain a solid D; and
Step 5: the solid D obtained in step 4 was placed in a corundum crucible and then heated at a heating rate of 5° C./min to 600° C. and kept at the temperature for 6 h in a muffle furnace for calcination to obtain the Fenton-like catalyst material with an electron-poor Cu center in which a mass fraction of Bi₁₂O₁₅Cl₆ was 29.6%.

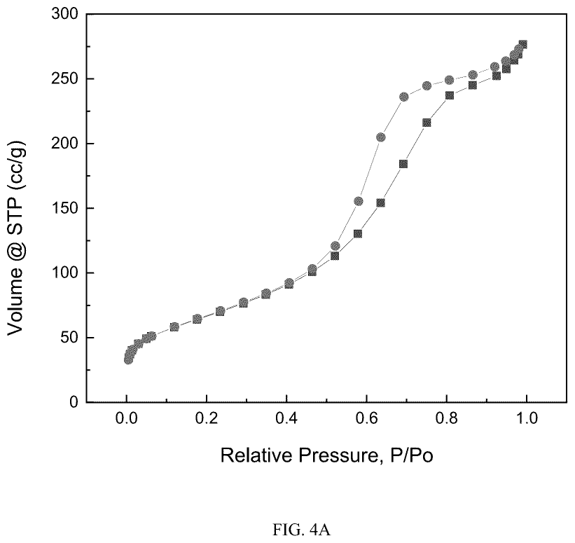

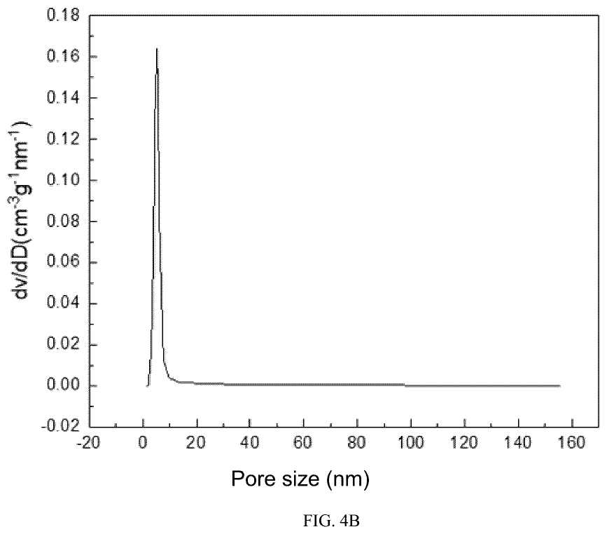

The catalyst material prepared above was subjected to N₂ adsorption and desorption isotherm and pore size distribution tests. It can be seen from FIGS. 4A-4B that the N₂ absorption/desorption isotherm of (Bi, Cu)Al₂O₃ is an IV isotherm with an H3 hysteresis curve, indicating a slit-like mesoporous structure. The first hysteresis loop at a relative pressure P/PO of 0.4 to 0.8 indicates that there are mainly mesopores in the synthesized sample and the second small hysteresis loop at a relative pressure P/PO of 0.8 to 1.0 indicates that there are a small number of large mesopores in the catalyst. It can be seen from the pore size distribution curve that mesopore sizes of the cotton-like (Bi, Cu)Al₂O₃ are mainly distributed at about 7.1 nm, and according to nitrogen adsorption and desorption isotherm calculation, the (Bi, Cu)Al₂O₃ has an SSA of 240 m²/g and a pore volume of 0.454 cm³/g.

A 20 mg/L BPA solution was prepared in a 150 mL Erlenmeyer flask, 0.1 g of the catalyst material obtained in step 5 was added to the Erlenmeyer flask, and a resulting mixture was stirred in a constant-temperature water bath at 35° C. for 30 minutes to achieve an adsorption equilibrium. Then 0.1 mL of a hydrogen peroxide solution with a mass fraction of 30% was added and then 1 mL of a reaction solution was collected every 5 minutes; filtered through a 0.45 m filter membrane and subjected to HPLC analysis to obtain BPA concentrations at different reaction time points. Test results were shown in FIG. 10.

### Example 4

In this example, a preparation method of a Fenton-like catalyst material with an electron-poor Cu center was provided, including the following steps:
Step 1: 2 g of bismuth nitrate pentahydrate was dissolved in 5 mL of a nitric acid solution (2 M), and a resulting solution was diluted with deionized water to 100 mL to obtain a solution A;
Step 2: 0.3 g of citric acid was dissolved in solution A obtained in step 1, a resulting solution was stirred at a rate of 100 r/min, and a pH was adjusted with ammonia water to 6.5 to obtain a solution B;
Step 3: 8.4 g of AIP, 0.4 g of copper chloride dihydrate and 7.2 g of glucose were added to the solution B obtained in step 2 and a resulting mixture was stirred at a rate of 100 r/min for 12 h to obtain a solution C;
Step 4: the solution C obtained in step 3 was placed in an electrothermal furnace and then heated and stirred at 100° C. until the water was completely evaporated to obtain a solid D; and
Step 5: the solid D obtained in step 4 was placed in a corundum crucible and then heated at a heating rate of 5° C./min to 600° C. and kept at the temperature for 6 h in a muffle furnace for calcination to obtain the Fenton-like catalyst material with an electron-poor Cu center in which a mass fraction of Bi₁₂O₁₅Cl₆ was 30.3%.

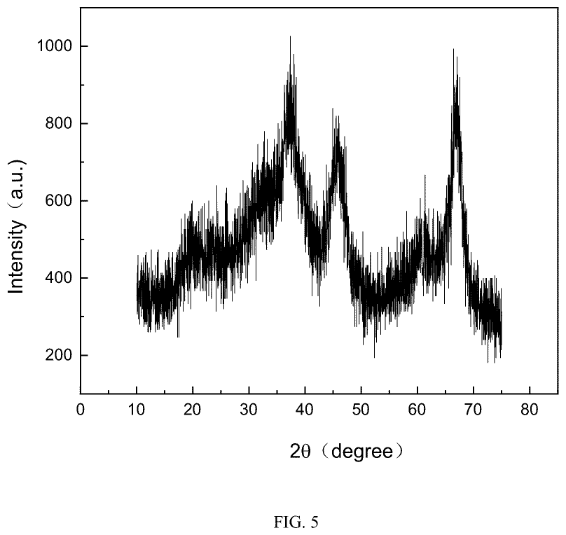

The catalyst material prepared above was subjected to an XRD test. It can be seen from FIG. 5 that a diffraction peak corresponding to copper cannot be observed in the XRD pattern of (Bi, Cu)Al₂O₃. However, new peaks appear in the XRD pattern of the catalyst doped with Bi₁₂O₁₅Cl₆, most of which correspond to Bi₁₂O₁₅Cl₆. The strongest diffraction peak at 20 of 30.12° is attributed to the (413) plane of Bi₁₂O₁₅Cl₆, indicating that the (413) plane is a preferred orientation for the formation of a crystal plane of the crystal.

A 20 mg/L BPA solution was prepared in a 150 mL Erlenmeyer flask, 0.1 g of the catalyst material obtained in step 5 was added to the Erlenmeyer flask, and a resulting mixture was stirred in a constant-temperature water bath at 35° C. for 30 minutes to achieve an adsorption equilibrium; and then 0.1 mL of a hydrogen peroxide solution with a mass fraction of 30% was added. Then 1 mL of a reaction solution was collected every 5 minutes, filtered through a 0.45 m filter membrane, and subjected to HPLC analysis to obtain BPA concentrations at different reaction time points. Test results were shown in FIG. 10.

### Example 5

In this example, a preparation method of a Fenton-like catalyst material with an electron-poor Cu center was provided, including the following steps:
Step 1: 2.64 g of bismuth nitrate pentahydrate was dissolved in 5 mL of a nitric acid solution (2 M) and a resulting solution was diluted with deionized water to 100 mL to obtain a solution A;
Step 2: 0.3 g of citric acid was dissolved in solution A obtained in step 1, a resulting solution was stirred at a rate of 100 r/min, and a pH was adjusted with ammonia water to 6.5 to obtain a solution B;
Step 3: 8.4 g of AIP, 0.4 g of copper chloride dihydrate and 7.2 g of glucose were added to the solution B obtained in step 2 and a resulting mixture was stirred at a rate of 100 r/min for 12 h to obtain a solution C;
Step 4: the solution C obtained in step 3 was placed in an electrothermal furnace and heated and stirred at 100° C. until the water was completely evaporated to obtain a solid D; and
Step 5: the solid D obtained in step 4 was placed in a corundum crucible and heated at a heating rate of 5° C./min to 600° C. and kept at the temperature for 6 h in a muffle furnace for calcination to obtain the Fenton-like catalyst material with an electron-poor Cu center in which a mass fraction of Bi₁₂O₁₅Cl₆ was 42.1%.

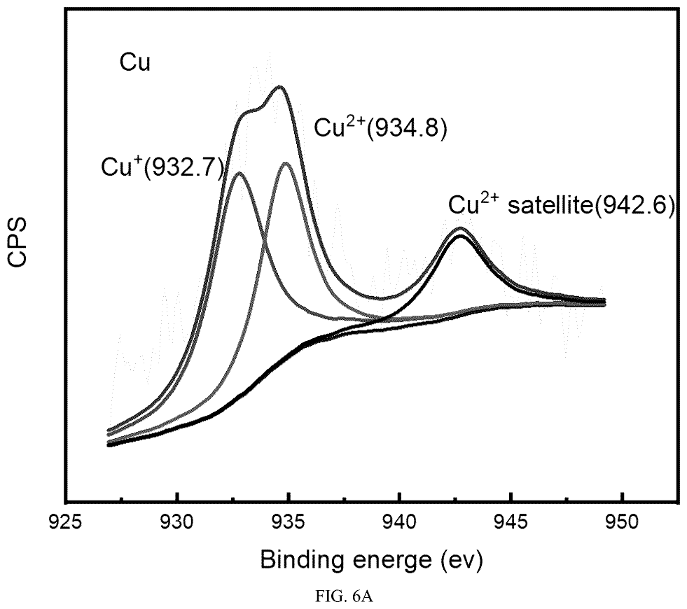

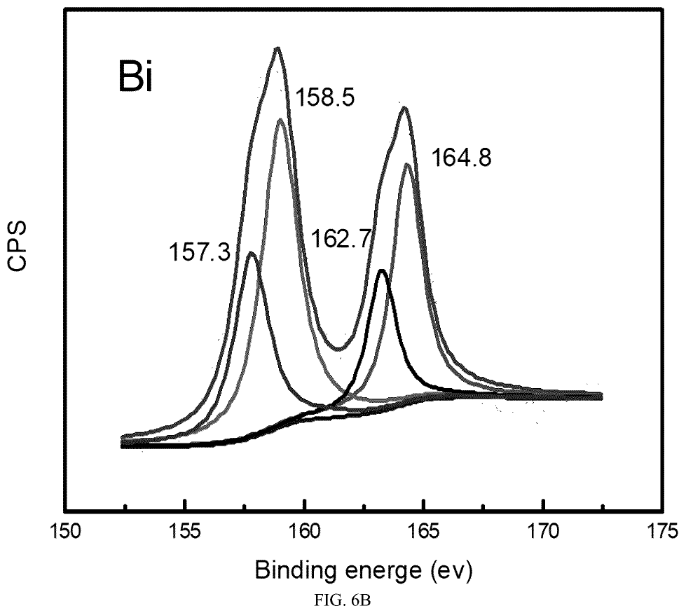

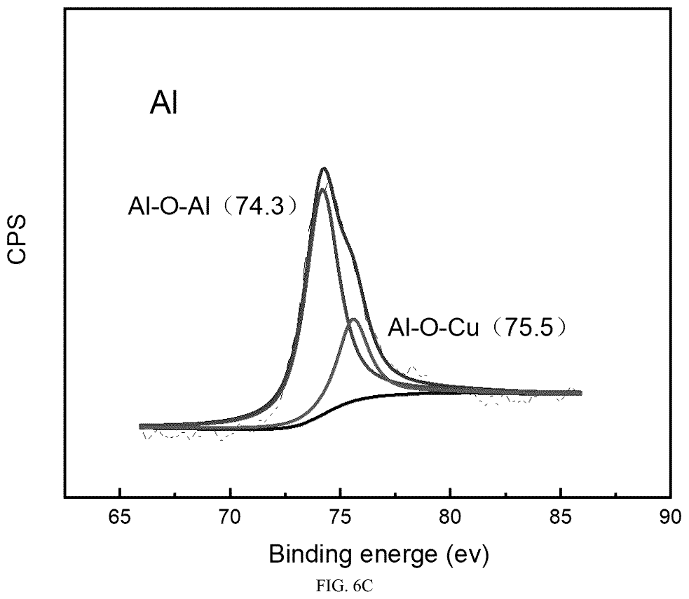

The catalyst material prepared above was characterized by XPS. It can be seen from FIGS. 6A-6C that the two binding energies (BEs) of Al³⁺ at 74.2 eV and 75.3 eV in the spectrum of (Bi, Cu)Al₂O₃ correspond to Al—O—Al and Al—O—Cu, respectively. In addition, an XPS spectrum of Cu in 0.64 CAB was determined. The three peaks 932.7 eV, 934.0 eV, and 942.4 eV obtained after fitting correspond to a reduced state, an oxidized state and a wave peak of copper, respectively. After Bi₁₂O₁₅Cl₆ is doped into γ-Cu—Al₂O₃, Bi has two characteristic peaks of Bi 4f_{7/2} (158.3 eV) and Bi 4f_{5/2} (163.7 eV). In addition, oxygen vacancies (OVs) can be formed during the calcination of BiOCl, and with the generation of low-charge Bi ions (Bi^{(3-x)+}) [28,29], local electrons on OVs are transferred to Bi³⁺. Therefore, new peaks with low binding energies (157.3 eV, 162.7 eV) will appear in the spectrum of Bi₁₂O₁₅Cl₆.

A 20 mg/L BPA solution was prepared in a 150 mL Erlenmeyer flask, 0.1 g of the catalyst material obtained in step 5 was added to the Erlenmeyer flask, and a resulting mixture was stirred in a constant-temperature water bath at 35° C. for 30 minutes to achieve an adsorption equilibrium. Then 0.1 mL of a hydrogen peroxide solution with a mass fraction of 30% was added and 1 mL of a reaction solution was collected every 5 minutes, filtered through a 0.45 μm filter membrane, and subjected to HPLC analysis to obtain BPA concentrations at different reaction time points. Test results were shown in FIG. 10.

It can be seen from FIG. 10 that the Fenton-like catalyst in which a mass fraction of Bi₁₂O₁₅Cl₆ is 9% has an excellent degradation effect for BPA under neutral pH conditions, and a removal rate within 30 minutes reaches 95% or more.

### Example 6

In this example, a preparation method of a Fenton-like catalyst material with an electron-poor Cu center was provided, including the following steps:
Step 1: 3.28 g of bismuth nitrate pentahydrate was dissolved in 5 mL of a nitric acid solution (2 M) and a resulting solution was diluted with deionized water to 100 mL to obtain a solution A;
Step 2: 0.3 g of citric acid was dissolved in the solution A obtained in step 1 a resulting solution was stirred at a rate of 100 r/min and a pH was adjusted with ammonia water to 6.5 to obtain a solution B;
Step 3: 8.4 g of AIP, 0.4 g of copper chloride dihydrate, and 7.2 g of glucose were added to the solution B obtained in step 2 and a resulting mixture was stirred at a rate of 100 r/min for 12 h to obtain a solution C;
Step 4: the solution C obtained in step 3 was placed in an electrothermal furnace and then heated and stirred at 100° C. until the water was completely evaporated to obtain a solid D; and
Step 5: the solid D obtained in step 4 was placed in a corundum crucible and then heated at a heating rate of 5° C./min to 600° C. and kept at the temperature for 6 h in a muffle furnace for calcination to obtain the Fenton-like catalyst material with an electron-poor Cu center in which a mass fraction of Bi₁₂O₁₅Cl₆ was 50.4%.

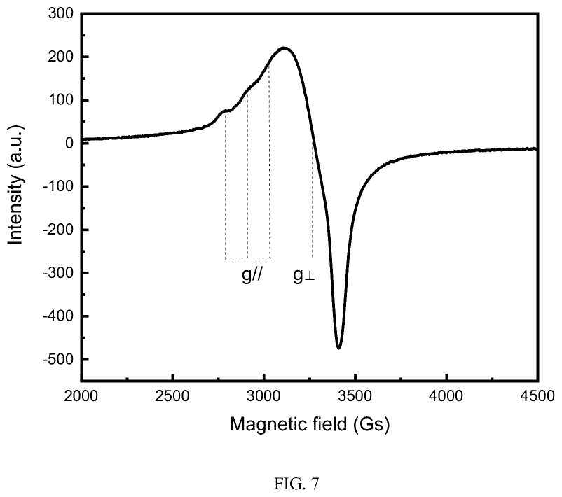

The catalyst material prepared above was subjected to solid EPR characterization. It can be seen from FIG. 7 that the solid EPR of Cu shows a strong signal accompanied by an ultra-fine coupling structure, which is a typical feature of Cu (II) with the spin I=3/2. The g factor and the A value of the Bi Cu Al₂O₃ sample were shown in the table below:

| Sample | g// | g⊥ | A//(G) |
|---|---|---|---|
| (Bi, Cu)Al₂O₃ | 2.403 | 2.130 | 130 |

g∥>g⊥>2.0023 (ge), indicating that the unpaired electrons present on the surface of the catalyst are located on the dx2-y2 orbit of Cu (II). A value range of the g factor and the shape of the EPR signal of (Bi, Cu)Al₂O₃ correspond to a form of Cu (II) present in the hexacoordinated octahedral geometry. The above results show that, due to a difference in electronegativity between Bi and Cu, the eutectic lattice doping of Cu in Al₂O₃ and the loading of Bi₁₂O₁₅Cl₆ cause non-uniform distribution of electrons on the surface of the catalyst; and because the electronegativity of Bi is higher than that of Cu, a density of electron cloud around Cu is weakened to produce an electron-poor Cu center, which correspondingly leads to an electron-rich Bi center.

### Example 7

In this example, a preparation method of a Fenton-like catalyst material with an electron-poor Cu center was provided, including the following steps:
Step 1: 0.64 g of bismuth nitrate pentahydrate was dissolved in 5 mL of a nitric acid solution (2 M) and a resulting solution was diluted with deionized water to 100 mL to obtain a solution A;
Step 2: 0.6 g of citric acid was dissolved in solution A obtained in step 1 a resulting solution was stirred at a rate of 100 r/min, and a pH was adjusted with ammonia water to 6.5 to obtain a solution B;
Step 3: 8.4 g of AIP, 0.4 g of copper chloride dihydrate and 7.2 g of glucose were added to the solution B obtained in step 2 and a resulting mixture was stirred at a rate of 100 r/min for 12 h to obtain a solution C;
Step 4: the solution C obtained in step 3 was placed in an electrothermal furnace and then heated and stirred at 100° C. until the water was completely evaporated to obtain a solid D; and
Step 5: the solid D obtained in step 4 was placed in a corundum crucible and then heated at a heating rate of 5° C./min to 600° C. and kept at the temperature for 6 h in a muffle furnace for calcination to obtain the Fenton-like catalyst material with an electron-poor Cu center in which a mass fraction of Bi₁₂O₁₅Cl₆ was 10.3%.

A 20 mg/L BPA solution was prepared in a 150 mL Erlenmeyer flask, 0.1 g of the catalyst material obtained in step 5 was added to the Erlenmeyer flask, and a resulting mixture was stirred in a constant-temperature water bath at 35° C. for 30 minutes to achieve an adsorption equilibrium. Then 0.1 mL of a hydrogen peroxide solution with a mass fraction of 30% was added and then 1 mL of a reaction solution was collected every 5 minutes, filtered through a 0.45 m filter membrane, and subjected to HPLC analysis to obtain BPA concentrations at different reaction time points. Test results were shown in FIG. 10.

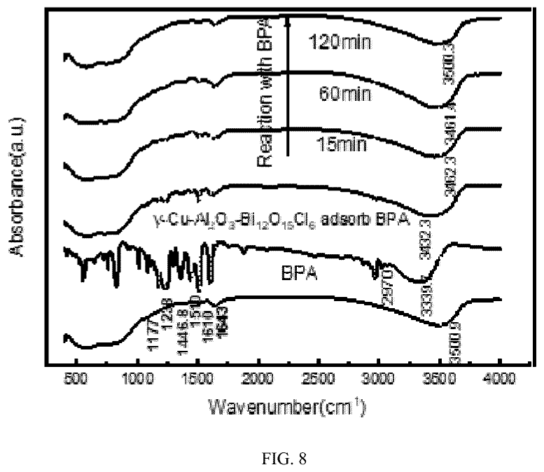

Fourier transform-infrared spectroscopy (FTIR) spectra of (Bi, Cu)Al₂O₃ at different reaction time points were determined to analyze a surface reaction process of the catalyst (FIG. 8). The two absorption bands of the freshly-prepared (Bi, Cu)Al₂O₃ at 3,500.9 cm⁻¹ and 1,643 cm⁻¹ correspond to a stretching vibration of OH and a mixed vibration of H—O—H, respectively. Characteristic peaks of —OH and —CH₃ of BPA appear at 3,339.7 cm⁻¹ and 2,970 cm⁻¹, respectively. The peaks at 1,446.8 cm⁻¹, 1,510 cm⁻¹, and 1,610 cm⁻¹ are attributed to a skeletal vibration of an aromatic ring of BPA; and the characteristic peaks in a range from 1,177 cm⁻¹ to 1,238 cm⁻¹ indicate a C—O stretching vibration of phenolic hydroxyl. After BPA is adsorbed, the phenolic hydroxyl of BPA forms a first coordination phase with Cu (II). Due to a difference between a deprotonation environment of phenolic hydroxyl of BPA and a surrounding environment, the characteristic peak of —OH shifts from 3,339.7 cm⁻¹ to 3,423 cm⁻¹. In addition, some characteristic peaks of BPA also appear in the spectrum of (Bi, Cu)Al₂O₃ after adsorption. With the extension of reaction time, the characteristic peaks of the aromatic ring of BPA (1,446.8 cm⁻¹, 1,510 cm⁻¹, and 1,610 cm⁻¹) gradually disappear. After 12 h of reaction, the characteristic peaks of all organic matters disappear, and the v(OH) band of (Bi, Cu)Al₂O₃ (0.64 CAB) shifts back to 3,500.3 cm⁻¹, indicating the complete mineralization of BPA and an intermediate thereof.

### Example 8

In this example, a preparation method of a Fenton-like catalyst material with an electron-poor Cu center was provided, including the following steps:
Step 1: 0.64 g of bismuth nitrate pentahydrate was dissolved in 5 mL of a nitric acid solution (2 M) and a resulting solution was diluted with deionized water to 100 mL to obtain a solution A;
Step 2: 0.9 g of citric acid was dissolved in solution A obtained in step 1 a resulting solution was stirred at a rate of 100 r/min, and a pH was adjusted with ammonia water to 6.5 to obtain a solution B;
Step 3: 8.4 g of AIP, 0.4 g of copper chloride dihydrate and 7.2 g of glucose were added to the solution B obtained in step 2 and a resulting mixture was stirred at a rate of 100 r/min for 12 h to obtain a solution C;
Step 4: the solution C obtained in step 3 was placed in an electrothermal furnace and then heated and stirred at 100° C. until the water was completely evaporated to obtain a solid D; and
Step 5: the solid D obtained in step 4 was placed in a corundum crucible and then heated at a heating rate of 5° C./min to 600° C. and kept at the temperature for 6 h in a muffle furnace for calcination to obtain the Fenton-like catalyst material with an electron-poor Cu center in which a mass fraction of Bi₁₂O₁₅Cl₆ was 10.3%.

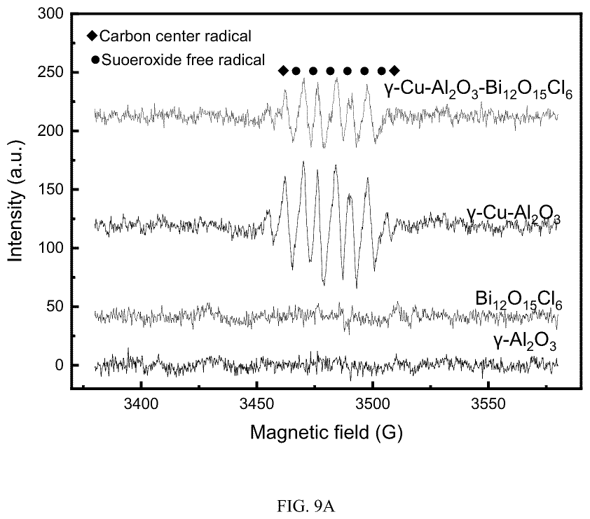

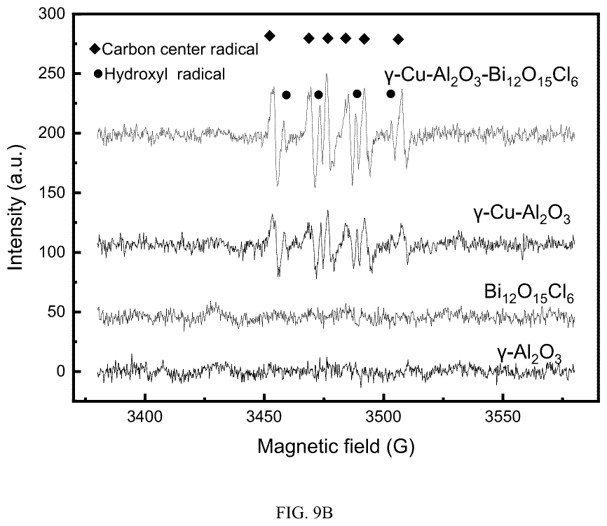

To further elucidate a catalysis mechanism, DMPO-captured EPR signals were detected in different dispersions of a corresponding sample (FIGS. 9A-9B). In the absence of H₂O₂, no signal was detected in a methanol dispersion of pure Al₂O₃ and Bi₁₂O₁₅Cl₆. However, intensities of the six characteristic peaks of DMPO—O₂·⁻ are as follows: γ-Cu—Al₂O₃>(Bi, Cu)Al₂O₃. Other peaks correspond to carbon-centered radicals produced by a reaction between DMPO and O₂·⁻. These peaks overlap with the characteristic peaks of DMPO—O₂·⁻, and thus can hardly be identified in the EPR spectrum. The reaction between the electron-rich center and O₂ can produce O₂·⁻. Therefore, in the methanol dispersion system of (Bi, Cu)Al₂O₃, Bi₁₂O₁₅Cl₆ can be used as an electron-rich center to reduce O₂ into O₂·⁻. Since the electron-poor Cu center oxidizes H₂O into ·OH, the characteristic peak of DMPO—OH· is observed in the γ-Cu—Al₂O₃ aqueous solution and the (Bi, Cu)Al₂O₃ aqueous solution, and the intensity of the characteristic peak is as follows: (Bi, Cu)Al₂O₃>γ-Cu—Al₂O₃. In addition, OH attacks the carbon-containing compound (DMPO) to form a carbon-centered radical adduct [45], and six other peaks appear.

### Example 9

In this example, a preparation method of a Fenton-like catalyst material with an electron-poor Cu center was provided, including the following steps:
Step 1: 0.64 g of bismuth nitrate pentahydrate was dissolved in 5 mL of a nitric acid solution (2 M) and a resulting solution was diluted with deionized water to 100 mL to obtain a solution A;
Step 2: 0.6 g of citric acid was dissolved in solution A obtained in step 1 a resulting solution was stirred at a rate of 100 r/min and a pH was adjusted with ammonia water to 6.5 to obtain a solution B;
Step 3: 8.4 g of AIP, 0.4 g of copper chloride dihydrate and 7.2 g of glucose were added to the solution B obtained in step 2 and a resulting mixture was stirred at a rate of 100 r/min for 12 h to obtain a solution C;
Step 4: the solution C obtained in step 3 was placed in an electrothermal furnace and then heated and stirred at 100° C. until the water was completely evaporated to obtain a solid D; and
Step 5: the solid D obtained in step 4 was placed in a corundum crucible and then heated at a heating rate of 5° C./min to 550° C. and kept at the temperature for 6 h in a muffle furnace for calcination to obtain the Fenton-like catalyst material with an electron-poor Cu center in which a mass fraction of Bi₁₂O₁₅Cl₆ was 10.3%.

### Example 10

In this example, a preparation method of a Fenton-like catalyst material with an electron-poor Cu center was provided, including the following steps:
Step 1: 0.64 g of bismuth nitrate pentahydrate was dissolved in 5 mL of a nitric acid solution (2 M) and a resulting solution was diluted with deionized water to 100 mL to obtain a solution A;
Step 2: 0.6 g of citric acid was dissolved in solution A obtained in step 1 a resulting solution was stirred at a rate of 100 r/min and a pH was adjusted with ammonia water to 6.5 to obtain a solution B;
Step 3: 8.4 g of AIP, 0.4 g of copper chloride dihydrate and 7.2 g of glucose were added to the solution B obtained in step 2 and a resulting mixture was stirred at a rate of 100 r/min for 12 h to obtain a solution C;
Step 4: the solution C obtained in step 3 was placed in an electrothermal furnace and then heated and stirred at 100° C. until the water was completely evaporated to obtain a solid D; and
Step 5: the solid D obtained in step 4 was placed in a corundum crucible and then heated at a heating rate of 5° C./min to 650° C. and kept at the temperature for 6 h in a muffle furnace for calcination to obtain the Fenton-like catalyst material with an electron-poor Cu center in which a mass fraction of Bi₁₂O₁₅Cl₆ was 10.3%.

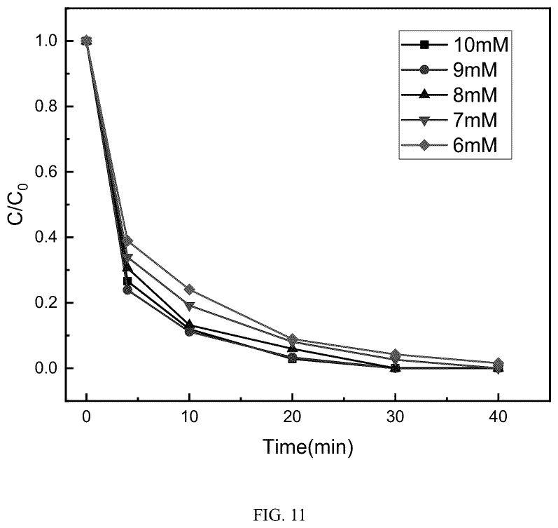

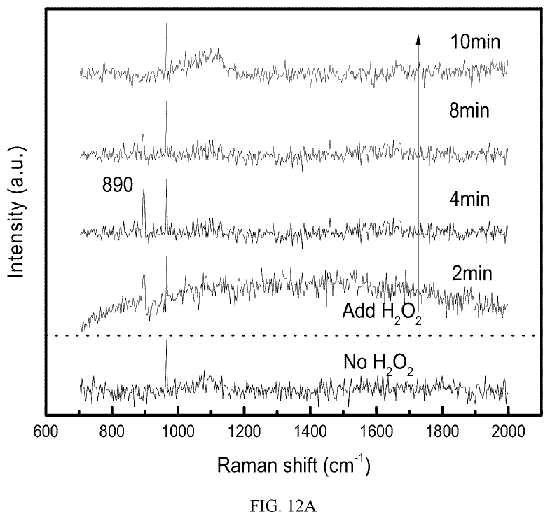

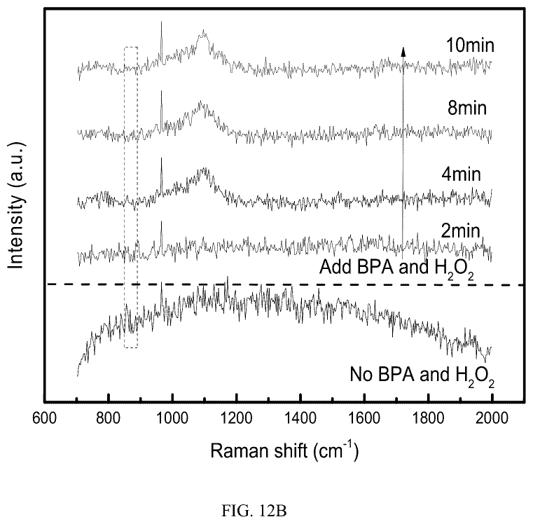

A 20 mg/L BPA solution was prepared in a 150 mL Erlenmeyer flask, 0.1 g of the catalyst material obtained in step 5 was added to the Erlenmeyer flask, and a resulting mixture was stirred in a constant-temperature water bath at 35° C. for 30 minutes to achieve an adsorption equilibrium. Then 0.1 mL of a hydrogen peroxide solution with a mass fraction of 30% was added and 1 mL of a reaction solution was collected every 5 minutes, filtered through a 0.45 μm filter membrane, and subjected to IPLC analysis to obtain BPA concentrations at different reaction time points. It can be seen from FIG. 11 that the Fenton-like catalyst can rapidly degrade BPA at a hydrogen peroxide concentration of 8 mmol/L under neutral pH conditions, and a removal rate within 30 minutes reaches 95% or more.

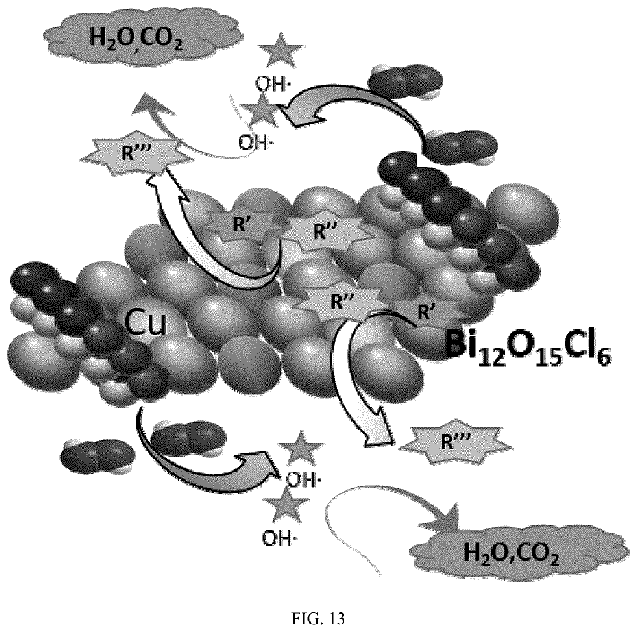

An experimental principle is as follows: Unlike the traditional catalyst with an electron-rich copper center, as shown in FIG. 13, in the [(Bi, Cu)Al₂O₃+H₂O₂+ phenolic compound] system, the electron-poor copper center is conducive to the formation of σ-Cu-ligand with a phenolic compound. Such σ-Cu-ligand were preferentially oxidized by H₂O₂ with the generation of ·OH and HO-adduct radicals, and the HO-adduct radicals reduced Cu(II) to Cu(I) subsequently. Therefore, σ-Cu-ligand can not only prevent Cu (II) from oxidizing H₂O₂ into HO₂·/O₂·⁻, but also enhance the oxidation-reduction cycle of Cu (II)/Cu (I). Notably, although the σ-Cu-ligand is gradually decreased over time due to the degradation of the phenolic compound, the dual-reaction center can still play an important role in the subsequent catalysis reaction. The electron-rich Bi center can reduce H₂O₂ into ·OH to degrade an organic matter. Therefore, during the degradation of a phenolic compound, three electron transfer routes can produce ·OH: (1) A first transfer route is from σ-Cu-ligand to H₂O₂, which is accompanied by the generation of ·OH and the reduction of Cu (II) into Cu (I). (2) A second transfer route is from Cu (I) to H₂O₂, which is accompanied by the generation of ·OH. (3) A third transfer route refers to the transfer from the electron-rich Bi center to H₂O₂ with the generation of OH. Due to the synergistic effect between the σ-Cu-ligand and the dual-reaction center, (Bi, Cu)Al₂O₃ has high catalytic activity and hydrogen peroxide utilization (i).

What is claimed is:

1. A preparation method of a Fenton-like catalyst material with an electron-poor Cu center, comprising the following steps:
step 1: dissolving bismuth nitrate pentahydrate in a nitric acid solution, and diluting a first resulting solution with deionized water to obtain a solution A;
step 2: adding citric acid to the solution A, and adjusting a pH of a second resulting solution with ammonia water to obtain a solution B;
step 3: dissolving aluminium isopropoxide (AIP), copper chloride dihydrate, and glucose in the solution B to obtain a suspension C;
step 4: stirring the suspension C at a high temperature to allow evaporation until a solid D is completely precipitated; and
step 5: subjecting the solid D to calcination in a muffle furnace to obtain the Fenton-like catalyst material with the electron-poor Cu center.

2. The preparation method of the Fenton-like catalyst material with the electron-poor Cu center according to claim 1, wherein
in step 1, the nitric acid solution has a concentration of 1 mol/L to 2 mol/L, and a ratio of the bismuth nitrate pentahydrate to the nitric acid solution is (0.32-3.28) g:5 mL.

3. The preparation method of the Fenton-like catalyst material with the electron-poor Cu center according to claim 1, wherein
a ratio of the citric acid to the bismuth nitrate pentahydrate is (0.3-0.9) g:(0.32-3.28) g.

4. The preparation method of the Fenton-like catalyst material with the electron-poor Cu center according to claim 1, wherein
in step 2, the pH of the second resulting solution is adjusted with the ammonia water to 5 to 9.

5. The preparation method of the Fenton-like catalyst material with the electron-poor Cu center according to claim 1, wherein
in step 3, the AIP, the copper chloride dihydrate, and the glucose are added in a ratio of (6.0-9.0) g:(0.1-0.8) g:(4.0-8.0) g.

6. The preparation method of the Fenton-like catalyst material with the electron-poor Cu center according to claim 1, wherein
in step 4, the high temperature is 100° C. and a rotational speed of the stirring is 100 r/min to 200 r/min.

7. The preparation method of the Fenton-like catalyst material with the electron-poor Cu center according to claim 1, wherein
in step 5, the calcination in the muffle furnace is conducted at 400° C. to 600° C. for 3 h to 7 h with a heating rate of 5° C./min to 10° C./min.

8. A Fenton-like catalyst material with an electron-poor Cu center prepared by the preparation method according to claim 1, wherein the Fenton-like catalyst material with the electron-poor Cu center has a structural formula of (Bi,Cu)Al₂O₃, wherein a mass fraction of Cu is 3.0% to 9.0% and a mass fraction of Bi₁₂O₁₅Cl₆ is 5.4% to 50.4%.

9. A method of using the Fenton-like catalyst material with the electron-poor Cu center according to claim 8, wherein the Fenton-like catalyst material with the electron-poor Cu center is provided in combination with H₂O₂ in water to degrade an organic pollutant.

10. The method of the use of the Fenton-like catalyst material with the electron-poor Cu center according to claim 9, wherein the organic pollutant is any one selected from the group consisting of rhodamine B, bisphenol A (BPA), and dichlorophenol (DCP).

11. The Fenton-like catalyst material with the electron-poor Cu center according to claim 8, wherein
in step 1, the nitric acid solution has a concentration of 1 mol/L to 2 mol/L, and a ratio of the bismuth nitrate pentahydrate to the nitric acid solution is (0.32-3.28) g:5 mL.

12. The Fenton-like catalyst material with the electron-poor Cu center according to claim 8, wherein
a ratio of the citric acid to the bismuth nitrate pentahydrate is (0.3-0.9) g:(0.32-3.28) g.

13. The Fenton-like catalyst material with the electron-poor Cu center according to claim 8, wherein
in step 2, the pH of the second resulting solution is adjusted with the ammonia water to 5 to 9.

14. The Fenton-like catalyst material with the electron-poor Cu center according to claim 8, wherein
in step 3, the AIP, the copper chloride dihydrate, and the glucose are added in a ratio of (6.0-9.0) g:(0.1-0.8) g:(4.0-8.0) g.

15. The Fenton-like catalyst material with the electron-poor Cu center according to claim 8, wherein
in step 4, the high temperature is 100° C. and a rotational speed of the stirring is 100 r/min to 200 r/min.

16. The Fenton-like catalyst material with the electron-poor Cu center according to claim 8, wherein
in step 5, the calcination in the muffle furnace is conducted at 400° C. to 600° C. for 3 h to 7 h with a heating rate of 5° C./min to 10° C./min.
